(19) United States
(12) Patent Application Publication
(10) Pub. No.: US 2006/0062460 A1
(43) Pub. Date: Mar. 23, 2006

(54) Character recognition apparatus and method for recognizing characters in an image

(75) Inventors: Sun Jun, Beijing (CN); Yutaka Katsuyama, Kawasaki (JP); Satoshi Naoi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/199,993

(22) Filed: Aug. 10, 2005

(30) Foreign Application Priority Data
Aug. 10, 2004 (CN) 200410058334.0

(51) Int. Cl. G06K 9/18

(52) U.S. Cl. 382/182

(57) ABSTRACT

Character recognition apparatus and method for recognizing characters in an image, of which the character recognition apparatus comprises a text line extraction unit for extracting a plurality of text lines from an input image, a feature recognition unit for recognizing one or more features of each of the text lines, a synthetic pattern generation unit for generating synthetic character images for each of the text lines by using the features recognized by the feature recognition unit and the original character images, a synthetic dictionary generation unit for generating a synthetic dictionary for each of the text lines by using the synthetic character images, and a text line recognition unit for recognizing characters in each of the text lines by using the synthetic dictionary.

### FIELD OF THE INVENTION

The present invention relates to a character recognition technology, and particularly, to a character recognition apparatus and a character recognition method for recognizing characters in an image.

### DESCRIPTION OF THE PRIOR ART

Character recognition technology is widely used in various fields of common, everyday life, including the recognition of characters in still images and in dynamic images (video images). One kind of video images, lecture video, is commonly used in e-Learning, and other educational and training environments. In a typical lecture video, a presenter uses a slide image as the background while he or she speaks. There is usually a great amount of text information in the lecture videos, which are very useful for content generation, indexing, and searching.

The recognition performance for characters in lecture video is rather low because the character images to be recognized are usually blurred and have small sizes, whereas the dictionary used in recognition is obtained from original clean character images.

In the prior art, the recognition for characters in lecture videos is the same as the recognition for characters in a scanned document. The characters are segmented and then recognized using a dictionary made from original clean characters.

There are many papers and patents about synthetic character image generation, such as:

P. Sarkar, G. Nagy, J. Zhou, and D. Lopresti. Spatial sampling of printed patterns. IEEE PAMI, 20 (3): 344-351, 1998

E. H. Barney Smith, X. H. Qiu, Relating statistical image differences and degradation features. LNCS 2423: 1-12, 2002

T. Kanungo, R. M. Haralick, I. Philips. “Global and Local Document Degradation Models,” Proceedings of IAPR 2^{nd} International Conference on Document Analysis and Recognition, Tsukuba, Japan, 1993 pp. 730-734

H. S. Baird, “Generation and use of defective images in image analysis”. U.S. Pat. No. 5,796,410.

However, there is no report on video character recognition using synthetic pattern by far.

Arai Tsunekazu, Takasu Eiji and Yoshii Hiroto once published a patent entitled “Pattern recognition apparatus which compares input pattern features and size data to registered feature and size pattern data, an apparatus for registering feature and size data, and corresponding methods and memory media therefore” (U.S. Pat. No. 6,421,461). In this patent, the inventors also extracted the size information of the testing characters, but they used this information to compare with the size information in a dictionary.

Therefore, there is a need to make improvement over the prior art to improve the recognition performance for characters.

### SUMMARY OF INVENTION

It is one object of the present invention to solve the problems pending in the prior art, namely to improve the recognition performance for characters while recognizing characters in an image.

According to the present invention, there is provided a character recognition apparatus for recognizing characters in an image, comprising:

a text line extraction unit for extracting a plurality of text lines from an input image;

a feature recognition unit for recognizing one or more features of each of the text lines;

a synthetic pattern generation unit for generating synthetic character images for each of the text lines by using the features recognized by the feature recognition unit and original character images;

a synthetic dictionary generation unit for generating a synthetic dictionary for each of the text lines by using the synthetic character images; and

a text line recognition unit for recognizing characters in each of the text lines by using the synthetic dictionary.

According to the present invention, there is further provided a character recognition method for recognizing characters in an image, comprising the steps of:

extracting text lines from an input image;

recognizing one or more features of each of the text lines;

generating synthetic character images for each of the text lines by using the recognized features and original character images;

generating a synthetic dictionary for each of the text lines by using the synthetic character images; and

recognizing characters in each of the text lines by using the synthetic dictionary.

In the present invention, by extracting beforehand certain features of the text to be recognized, and synthesizing these features with original character images to get synthetic characters and hence a synthetic dictionary, characters can be recognized by using a synthetic dictionary suitable for the text to be recognized. Consequently, the recognition performance for characters can be markedly improved.

### BRIEF DESCRIPTION OF THE DRAWINGS

FIG. 1 shows an overall flowchart of the present invention.

FIG. 2 shows an operation flowchart of frame text recognition unit.

FIG. 3 shows an operation flowchart of contrast estimation unit.

FIG. 4 shows an operation flowchart of synthetic pattern generation unit.

FIG. 5 shows an operation flowchart of synthetic dictionary generation unit.

FIG. 6 shows an operation flowchart of text line recognition unit.

### DESCRIPTION OF THE PREFERRED EMBODIMENTS

In the present invention, a text frame extraction unit is first used to extract a video frame that contains text information. Then, a frame text recognition unit is used to recognize the character content in the frame, image. In the frame text recognition unit, a font type identification unit is used to identify the font types of the characters in the image frame. A text line extraction unit is used to extract all the text lines from each of the text frame images. A contrast estimation unit is used to estimate the contrast value from each of the text line images. A shrinking level estimation unit is used to estimate the number of the patterns generated for each of original patterns. And then, a synthetic pattern generation unit is used to generate a group of synthetic character patterns using the estimated font type and contrast information. These synthetic character images are used to make synthetic dictionaries for each of the text lines. Finally, a character recognition unit is used to recognize the characters in each of the text lines using the generated synthetic dictionaries.

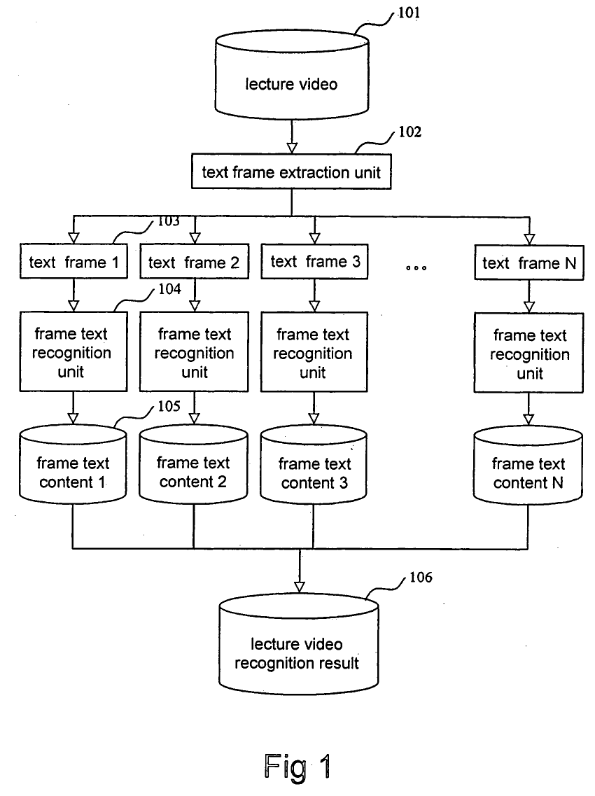

FIG. 1 shows an overall flowchart of the character recognition apparatus of the present invention. For instance, the input of the apparatus is a lecture video 101. A text frame extraction unit 102 is then used to extract a video frame with text information in the video. There are many prior art methods that can be used in unit 102, such as the method described in “Jun Sun, Yutaka Katsuyama, Satoshi Naoi: Text processing method for e-Learning videos, IEEE CVPR workshop on Document Image Analysis and Retrieval, 2003”. The result of the text frame extraction unit is a series of N text frames 103 that contain text information. For each frame of these text frames, a frame text recognition unit 104 is used to recognize the text within the frame. The output of the frame text recognition unit 104 is a recognized text content 105 of each of the frames. A combination of all the results from the frame text recognition constitutes a lecture video recognition result 106. Although there is a plurality of frame text recognition units 104 shown in this figure, it will in fact suffice for one frame text recognition unit 104 alone to process sequentially a plurality of text frames 103.

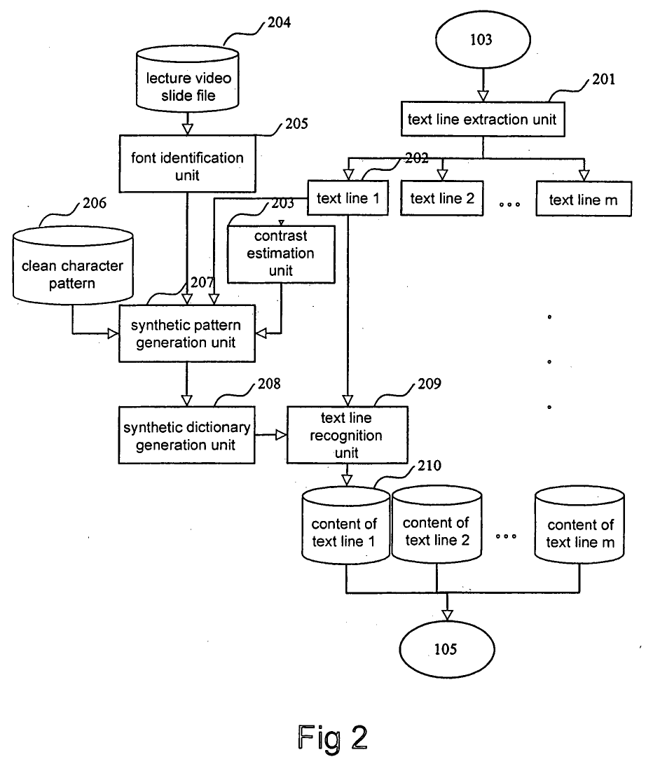

FIG. 2 shows an operation flowchart of the frame text recognition unit 104 in FIG. 1. A text line extraction unit 201 processes each of the text frames 103 in FIG. 1 to extract all text lines 202 in the frame. For each of the text lines, a contrast estimation unit 203 is used to estimate the contrast value in the region of the text line. At the same time, the slide file 204 of the lecture video is sent to a character font identification unit 205 to detect the font types of the characters in the video. Taking Microsoft PowerPoint software as an example, the PPT file is converted to HTML format. Then the font information can be extracted easily from the HTML file. For image files of other types, other suitable font information extraction methods can be used.

For each of the detected text line, given the estimated font types and contrast value, a synthetic pattern generation unit 207 is used to generate a set of synthetic character images using a set of clean character pattern images. And then a synthetic dictionary generation unit 208 is used to generate a synthetic dictionary using the output of unit 207. After that, a text line recognition unit 209 is used to recognize the characters in the text line using the generated synthetic dictionary. A combination of the recognized text line contents of all text lines constitutes the text content 105 in FIG. 1.

The specific method used in the text line extraction unit 201 can be referred from Jun Sun, Yutaka Katsuyama, Satoshi Naoi, “Text processing method for e-Learning videos”, IEEE CVPR workshop on Document Image Analysis and Retrieval, 2003.

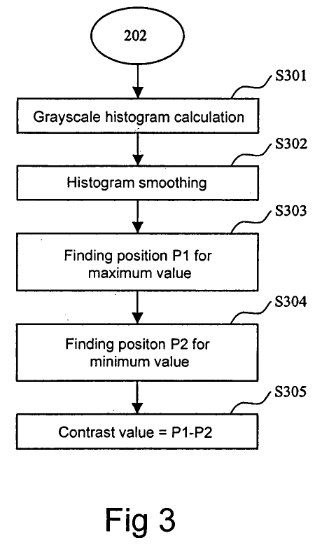

FIG. 3 shows an operation flowchart of the contrast estimation unit 203 in FIG. 2. The input of this unit is a frame of text line image 202 in FIG. 2. A grayscale histogram can be obtained from the text line image (S301). The algorithm for histogram calculation can be referred from K. R. Castleman, “Digital Image Processing”. Prentice Hall Press. 1996. The histogram smoothing step (S302) is used to smooth the histogram using the following operation:

$$prjs ( i ) = \frac{1}{2 δ + 1} {\sum }_{j = i - δ}^{i + δ} prj ( j ) ,$$

where prjs(i) is the smoothed value for position i, δ is the window size for the smoothing operation, and j is the current position during the smoothing operation. In the smoothed histogram, the positions for the maximum value and the minimum value are recorded (S303, S304). Then the contrast value is calculated as the difference of the two positions (S305).

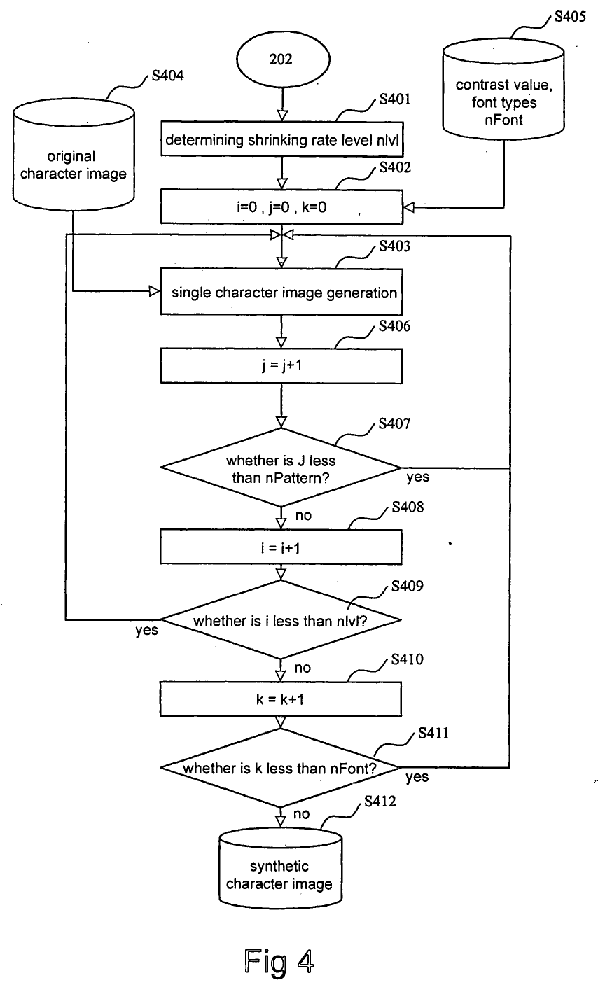

FIG. 4 shows an operation flowchart of the synthetic pattern generation unit 207 in FIG. 2. This unit takes the text line image 202 as input and determines the shrinking rate level nlvl using the height of the text line. The shrinking rate is a parameter used in the single character image generation unit (S403). The level of the shrinking rate determines the number of images generated for each of the original characters. For small sized characters, the degradation of the image is usually heavy, so a large shrinking rate level is needed. For big sized characters, the degradation is not very heavy, so a small shrinking rate level is sufficient. Provided that the number of original character patterns is npattern, and for each frame of these images, given the contrast value and font types estimated in unit 203 and 205 in FIG. 2, as well as the shrinking rate level obtained in unit S401, then a synthetic character image can be generated using the single character image generation unit (S403). The total number of the character images generated for each of the original text line is nPattern*nlvl*nFont, where nFont is the number of font types in the lecture video.

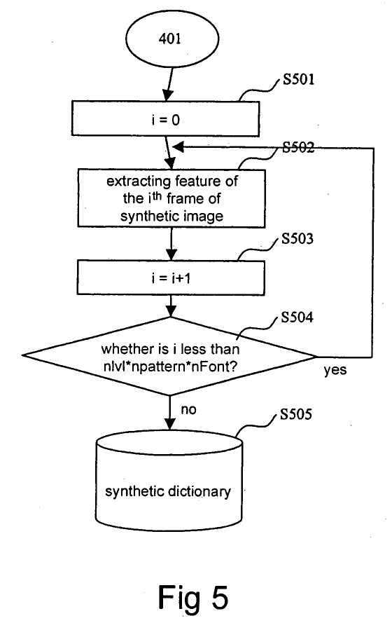

FIG. 5 shows an operation flowchart of the synthetic dictionary generation unit 208 in FIG. 2. A feature extraction unit is used to extract the feature of the character starting from the first frame (S501) of character images for the given synthetic character images 401(S502). There are a number of feature extraction methods that can be used in S502. For instance, one feature extraction method is M. Shridhar and F. Kimura's “Segmentation-Based Cursive Handwriting recognition”, Handbook of Character Recognition and Document Image Analysis: pp. 123-156, 1997. This process repeats itself until all features of the characters are extracted (S503 and S504). The output of the dictionary generation unit is the synthetic dictionary (S505).

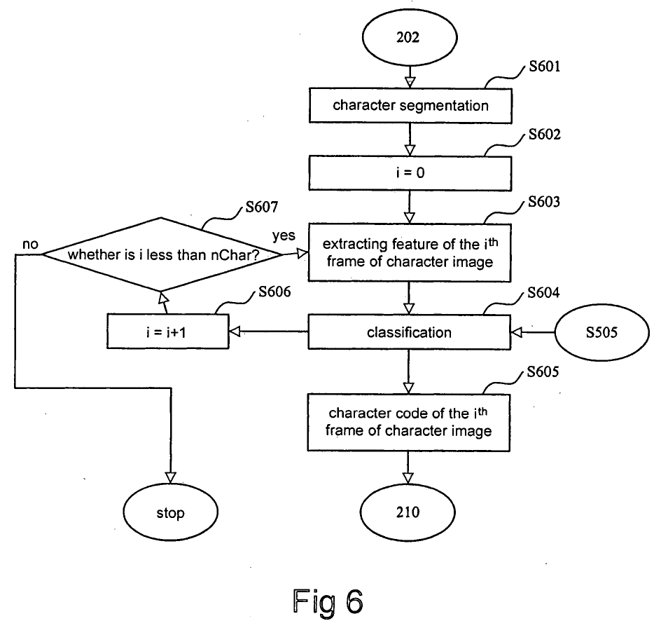

FIG. 6 shows an operation flowchart of the text line recognition unit 209 in FIG. 2. For a given text line image, a segmentation unit is first used to segment the text line image into nChar individual character images (S601). Then a feature extraction unit is used to extract the feature of the current character image starting from the first fame (S602) of character image (S603). The method used in S603 is the same as that used in S502. Subsequently, a classification unit is used to classify the category of each frame of character image according to the types of the characters using the synthetic dictionary S505 generated by the synthetic dictionary generation unit (S604). The output of this process is the character code (category) of the i^{th} frame of character image. The process repeats itself until all nChar character images are recognized by the synthetic dictionary (S606 and S607). The recognition result for all characters in the text line constitutes the content 210 of the text line in FIG. 2.

For a given text frame image, the recognition result for all the text lines in the image constitutes the recognition result of the content of this image. Finally, the combination of all the results in 105 constitutes the final output of the present invention, namely the recognition result of the lecture video.

It should be pointed out that, although the character recognition technology according to the present invention is explained above with reference to a lecture video image, the character recognition technology of the present invention is also applicable to other types of video images. Moreover, the character recognition technology of the present invention can likewise find application in such still images as scanned documents, photographs, and etc. Additionally, in the embodiments of the present invention, the features extracted from the text line to be recognized during the process of obtaining a synthetic dictionary are contrast, font and shrinking rate. However, the features extracted are not limited to one or more of these features, since it is also possible to additionally or alternatively extract other features of the text line.

1. A character recognition apparatus for recognizing characters in an images comprising:
a text line extraction unit extracting text lines from an input image;
a feature recognition unit recognizing one or more features of each of the text lines;
a synthetic pattern generation unit generating synthetic character images for each of the text lines by using the features recognized by the feature recognition unit and original character images;
a synthetic dictionary generation unit generating a synthetic dictionary for each of the text lines by using the synthetic character image; and
a text line recognition unit recognizing characters in each of the text lines by using the synthetic dictionary.

2. The apparatus of claim 1, wherein the feature recognition unit comprises a font type identification unit identifying the font type of the text lines.

3. The apparatus of claim 1, wherein the feature recognition unit comprises a contrast estimation unit estimating the contrast of the text lines.

4. The apparatus of claim 3, wherein the contrast estimation unit comprises a calculation unit calculating a grayscale value histogram of a text line, performing histogram smoothing, and calculating the contrast by using an average value of the grayscale value.

5. The apparatus of claim 4, wherein the synthetic pattern generation unit comprises a shrinking rate estimation unit estimating a level of a shrinking rate of the text line, and generates a set of synthetic character images for each level of the shrinking rate.

6. The apparatus of claim 1, wherein the text line recognition unit comprises:
a segmentation unit segmenting the a line into a plurality of individual character images;
a feature extraction unit extracting a feature of each character image;
a classification unit classifying the character images by using the synthetic dictionary.

7. The apparatus of claim 1, wherein the synthetic dictionary generation unit comprises a feature extraction unit extracting a feature of each synthetic character image.

8. The apparatus of claim 1, wherein the input image is a still image.

9. The apparatus of claim 5, wherein a number of the synthetic character images is determined by a number of font types, a number of the patterns of an original character image, and the shrinking rate.

10. The apparatus of claim 5, wherein the shrinking rate estimation unit comprises a unit determining a height of the text line, and determines the shrinking rate according to the height.

11. A character recognition method for recognizing characters in an image, comprising:
extracting text lines from an input image;
recognizing one or more features of each of the text lines;
generating synthetic character images for each of the text lines by using the recognized features and original character images;
generating a synthetic dictionary for each of the text lines by using the synthetic character images; and
recognizing characters in each of the text lines by using the synthetic dictionary.

12. The method of claim 11, wherein the recognizing one or more features of each of the text lines comprises identifying font types of the text lines.

13. The method of claim 11, wherein the recognizing one or more features of each of the text lines comprises estimating a contrast of each of the text lines.

14. The method of claim 13, wherein the estimating the contrast of each of the text lines comprises calculating a grayscale value histogram of a text line, performing histogram smoothing, and calculating the contrast by using an average value of the grayscale value.

15. The method of claim 14, wherein the generating the synthetic character images comprises estimating a level of a shrinking rate of each of the text lines, and generating a set of synthetic character images for each estimated level of the shrinking rate.

16. The method of claim 11, wherein the recognizing the characters in the text line comprises:
segmenting a text line into a plurality of individual character images;
extracting a feature of each character image; and
classifying the character images by using the synthetic dictionary.

17. The method of claim 11, wherein the generating the synthetic dictionary comprises extracting a feature of each synthetic character image.

18. The method of claim 11, wherein the input image is a still image.

19. The method of claim 15, wherein a number of the synthetic character images is determined by a number of font types, a number of the patterns of the original character images, and the shrinking rate.

20. The method of claim 15, wherein estimating the shrinking rate comprises determining a height of the text line, and determining the shrinking rate according to the height.

21. The apparatus of claim 1, wherein the input image signal is a video image.

22. The method of claim 11, wherein the input image signal is a video image.
